(19) United States
(12) Patent Application Publication
(10) Pub. No.: US 2025/0184439 A1
(43) Pub. Date: Jun. 5, 2025

(54) IMAGE PROCESSING APPARATUS

(71) Applicant: KYOCERA Document Solutions Inc., Osaka (JP)

(72) Inventors: Manabu Kitabayashi, Osaka (JP); Masayoshi Takahashi, Osaka (JP)

(21) Appl. No.: 18/966,053

(22) Filed: Dec. 2, 2024

(30) Foreign Application Priority Data
Dec. 5, 2023 (JP) 2023-205087

(51) Int. Cl. H04N 1/00; H04N 1/028

(52) U.S. Cl. CPC H04N 1/00933; H04N 1/00737; H04N 1/02815

(57) ABSTRACT

An SS clock is obtained by modulating a reference clock with a spread spectrum of a predetermined modulation period. A data processing unit derives a weighted moving average value of a density fluctuation component at each pixel clock from a difference between a reference board reading value in a turning-off period of a lighting device and black reference data in synchronization with modulation of the SS clock, derives at each pixel clock an average value of the weighted moving average values in plural modulation periods, and corrects image data on the basis of the derived average value. The weighted moving average value of a target pixel clock is a weighted average of the density fluctuation components of the target and peripheral pixel clocks, and a weighting coefficient to the density fluctuation component of the target clock is larger than those of the peripheral clocks.

### CROSS-REFERENCE TO RELATED APPLICATIONS

This application relates to and claims priority rights from Japanese Patent Application No. 2023-205087, filed on Dec. 5, 2023, the entire disclosures of which are hereby incorporated by reference herein.

### BACKGROUND

### 1. Field of the Present Disclosure

The present disclosure relates to an image processing apparatus.

### 2. Description of the Related Art

An image processing apparatus uses a spread spectrum clock generator (SSCG) to restrain unnecessary radiation, and due to the spread spectrum, noise occurs in line image data and deteriorates image quality, and therefore, the image processing apparatus detects the noise component, and performs correction of the image data so as to restrain the noise component on the basis of a value of the noise component.

Specifically, this image processing apparatus (a) derives for each line a line density fluctuation component from differences between a reference board reading values in a turning-off period of a lighting device and in a turning-on period of the lighting device and black and white reference data, (b) divides the line density fluctuation component by a difference between the black reference data and the white reference data and thereby corrects the line density fluctuation component, (c) derives an average of the corrected line density fluctuation components of a predetermined plural lines, (d) multiplies the average by the difference between the black reference data and the white reference data and thereby generates a correction value of the image data, and (e) corrects the image data on the basis of the correction value. Consequently, a distribution of the density fluctuation components in a primary scanning direction is determined without an influence of uneven light distribution of the lighting device.

In the aforementioned image processing apparatus, an average of the corrected line density fluctuation components of plural lines is derived and thereby a noise component in the correction value is reduced. In this manner, when the number of the lines increase, the noise component in the correction value decreases but a long time is required to derive the correction value.

### SUMMARY

An image processing apparatus according to an aspect of the present disclosure includes an image sensor, a lighting device, an SSCG circuit, an analog front end, a channel composition circuit, and a data processing unit. The image sensor is configured to detect an image of a document or a reference board. The lighting device is configured to irradiate the document or the reference board with light. The SSCG circuit is configured to generate an SS clock obtained by modulating a reference clock with a spread spectrum of a predetermined modulation period. The analog front end is configured to sample and hold an output signal of the image sensor with a sampling clock generated from the SS clock and thereby generate sampling data. The channel composition circuit is configured to convert the sampling data to image data. The data processing unit is configured to process the image data with a pixel clock generated on the basis of the SS clock. Further, the data processing unit (a) derives a weighted moving average value of a density fluctuation component at each pixel clock from a difference between a reference board reading value in a turning-off period of the lighting device and black reference data in synchronization with modulation of the SS clock, (b) derives at each pixel clock an average value of the weighted moving average values in plural modulation periods, and (c) corrects the image data on the basis of the average value of the weighted moving average values. Here, when each pixel clock is set as a target clock, the weighted moving average value of the target clock is a weighted average of the density fluctuation component of the target clock and the density fluctuation components of a predetermined number of peripheral clocks adjacent to the target clock; and a weighting coefficient to the density fluctuation component of the target clock is larger than weighting coefficients to the density fluctuation components of the peripheral clocks.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing apparatus according to an embodiment of the present disclosure;

FIG. 2 shows a side view that indicates a configuration of the image scanning unit 1 shown in FIG. 1;

FIG. 3 shows a diagram that explains an effect of weighted moving average of SS component data; and

FIG. 4 shows a diagram that explains correction of image data in an image processing apparatus of Embodiment 2.

### DETAILED DESCRIPTION

Hereinafter, embodiments according to an aspect of the present disclosure will be explained with reference to drawings.

### Embodiment 1

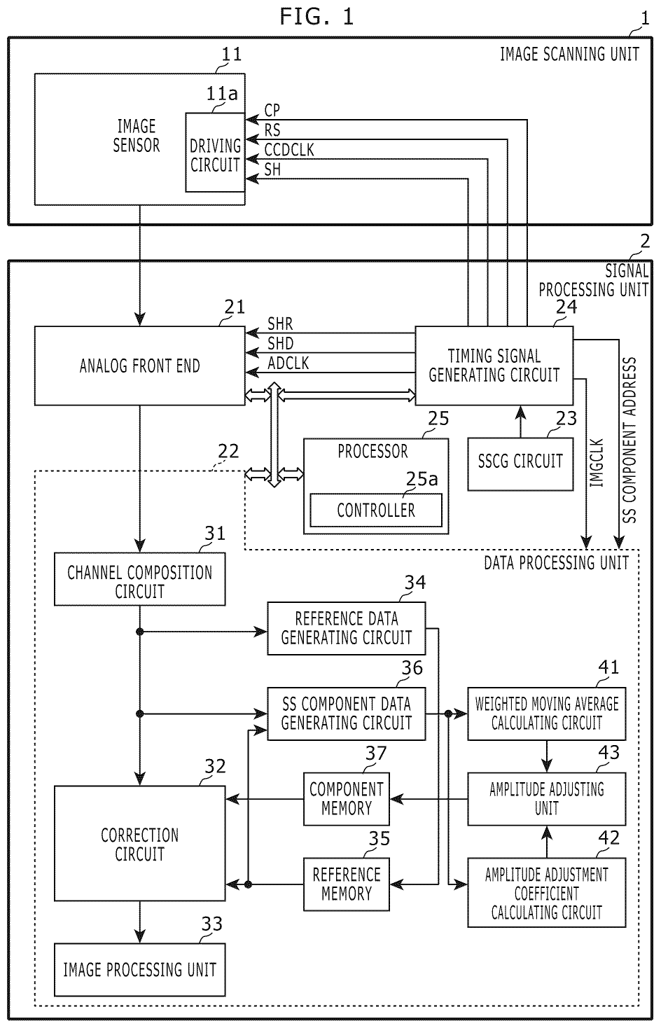

FIG. 1 shows a block diagram that indicates a configuration of an image processing apparatus according to an embodiment of the present disclosure. In this embodiment, the image processing apparatus shown in FIG. 1 is an image scanning apparatus such as scanner or multi function peripheral, and includes an image scanning unit 1 and a signal processing unit 2.

The image scanning unit 1 includes an image sensor 11. The image sensor 11 is driven in accordance with driving signals such as a clamp signal CP, a reset signal RS, a clock CCDCLK, and a shift pulse SH by a driving circuit 11a, and receives light of an image of a document or a reference board and thereby outputs an electric signal corresponding to the image.

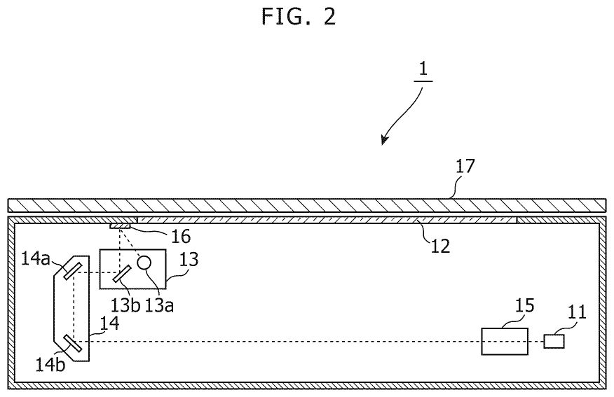

FIG. 2 shows a side view that indicates a configuration of the image scanning unit 1 shown in FIG. 1. As shown in FIG. 2, the image scanning unit 1 includes not only the image sensor 11 but a contact glass 12, carriages 13 and 14, an imaging lens 15, a reference board 16, and a platen cover 17. The contact glass 12 is arranged on a top surface of a main body of the image scanning unit 1, and a document is put on the contact glass 12. The carriage 13 is arranged so as to be capable of moving in a secondary scanning direction using an unshown driving source. The carriage 13 includes a light source 13a (lighting device) that outputs irradiation light to the document or the reference board, and a mirror 13b. The light source 13a is, for example, plural light emitting diodes arranged along a primary scanning direction. The light emitted from the light source 13a reflects with the reference board 16, a document put on the contact glass 12 or the like correspondingly to a position of the carriage 13. The mirror 13b is an optical element that reflects a reflection light from the reference board 16, the document or the like so as to output the light along a predetermined direction toward the carriage 14. The carriage 14 reflects the light from the mirror 13b using mirrors 14a and 14b, and outputs toward the imaging lens 15.

The imaging lens 15 focuses the light from the carriage 14 onto an image sensor 11.

The image sensor 11 receives the reflection light corresponding to the light emitted from the light source 13a through a predetermined optical system (here, the mirrors 13b, 14a, and 14b, and the imaging lens 15). The image sensor 11 outputs an electric signal corresponding to received light amounts on plural pixels in each line. In this embodiment, as the image sensor 11, a CCD (charge Coupled Device), a CIS (CMOS Image Sensor) or the like is used.

The reference board 16 is a board-shaped member that is arranged along the primary scanning direction on a ceiling surface in an inside of the apparatus, and is used to obtain reference data of white and black.

Returning to FIG. 1, the signal processing unit 2 includes an analog front end (AFE) 21, a data processing unit 22, an SSCG circuit 23, a timing signal generating circuit 24, and a processor 25. The data processing unit 22 includes a channel composition circuit 31, a correction circuit 32, an image processing unit 33, a reference data generating circuit 34, a reference memory 35, an SS component data generating circuit 36, a component memory 37, a weighted moving average calculating circuit 41, an amplitude adjustment coefficient calculating circuit 42, and an amplitude adjusting unit 43.

The analog front end (AFE) 21 is a circuit that performs sample-hold, AGC (automatic gain control), and A/D (Analog to Digital) conversion.

The AFE 21 samples and holds an output signal of the image sensor 11 at a timing specified with a sampling clock generated from an SS clock mentioned below, and thereby generates and outputs output data.

For example, the AFE 21 acts as a sample hold unit that samples and holds an output signal of the image sensor 11, and performs the sample-hold in a CDS (Correlated Double Sampling) manner. Specifically, the AFE 21 samples two values in accordance with a reset sampling clock SHR and a data sampling clock SHD, and outputs a difference between the two values.

The data processing unit 22 operates with the pixel clock IMGCLK generated on the basis of an SS clock mentioned below, converts the output data to image data, and performs a predetermined data process for the image data. The pixel clock IMGCLK is generated by performing frequency integer multiplication or frequency integer division to the SS clock.

Further, the data processing unit 22 corrects the image so as to restrain an SS component due to period data fluctuation of the SS clock.

Specifically, in synchronization with modulation of the SS clock, the data processing unit 22 derives a density fluctuation component for one modulation period from a difference between a reference board reading value in a turning-off period of the aforementioned lighting device and black reference data, and performs correction of the image data using this density fluctuation component. Here, an SS component address n is generated in synchronization with the SS clock, and the density fluctuation component is derived correspondingly to each SS component address n.

The SSCG circuit 23 oscillates and thereby generates a reference clock having a fixed period, and generates a clock (SS clock) obtained by modulating the reference clock in a spread spectrum manner with a predetermined modulation period. For example, the SSCG circuit 23 modulates the reference clock of 40 MHz with a modulation period of 2000 clocks and a center spread of #1 percent, and thereby generates the SS clock.

On the basis of the SS clock, the timing signal generating circuit 24 generates a driving signal to be supplied to the driving circuit 11a, and clock signals (sampling clocks SHR, SHD, clock ADCLK specifying an A/D conversion timing, and the like) to be supplied to the AFE 21. For example, the timing signal generating circuit 24 performs frequency integer multiplication and/or frequency integer division to the SS clock in accordance with a predetermined frequency integer multiplication setting value and/or a predetermined frequency integer division setting value, and thereby generates the aforementioned driving signal, the aforementioned clock signals such as pixel clock IMGCLK, and the like.

The processor 25 includes a CPU (Central Processing Unit), a ROM (Read Only Memory), a RAM (Random Access Memory) and the like, loads a program from the ROM or an unshown storage device to the RAM, and executes the program using the CPU and thereby acts as sorts of processing units. Here, the processor 25 acts as a controller 25a. The controller 25a sets an offset, a gain and the like of the AFE 21.

Further, in the data processing unit 22, the channel composition circuit 31 changes an order of output data of the AFE 21 and thereby outputs image data as RGB data in an order along a scanning direction.

For the aforementioned image data, the correction circuit 32 performs SS component correction that restrains an error component due to period fluctuation of the SS clock mentioned below (hereinafter, called “SS component”) and performs shading correction.

The image processing unit 33 performs a predetermined image process for the image data after the correction performed by the correction circuit 32, if required.

The reference data generating circuit 34 generates reference data on the basis of image data obtained by reading the reference board 16, and stores the reference data into the reference memory 35. The SS component data generating circuit 36 generates SS component data (i.e. data that indicates an SS component) on the basis of the image data obtained by reading the reference board 16 and the reference data, and stores the SS component data into the component memory 37. The correction circuit 32 performs correction of the image data using the reference data and the component data.

Specifically, the correction circuit 32 also corrects the image data so as to restrain the SS component using a reference board reading value that is obtained by reading the reference board 16 using the image sensor 11 under a turning-off status of the lighting device.

For example, the reference data generating circuit 34 generates black reference data (x) and white reference data (x) mentioned below and writes the black reference data (x) and the white reference data (x) into the reference memory 35, and the SS component generating circuit 36 generates SS component data SS0(n) as a density fluctuation component due to spread spectrum in accordance with the following formula.

SS0(n)=AVEn[Reference board reading value (x)−Black reference data (x)]
“n” is an SS component address, and takes a value counted up from zero with a pixel clock IMGCLK within a modulation period. The SS component address n is generated in synchronization with the pixel clock IMGCLK by the timing signal generating circuit 24, and is supplied to the data processing unit 22 (the correction circuit 32, the SS component data generating circuit 36 and the like).
AVEn[ ] indicates an average value in a predetermined number of plural modulation periods at each SS component address n.

The black reference data (x) is a value obtained by averaging pixel values at a primary scanning directional pixel position x of a predetermined number of plural lines under a turning-off status of the lighting device.

The number of the SS component addresses n is pixel clock number in a modulation period of SSCG, for example, and indicates a phase in the modulation period.

As mentioned, in each modulation period, SS component data is derived at each SS component address (i.e. at each pixel clock).

The weighted moving average calculating circuit 41 derives a weighted moving average values SS1(n) of the aforementioned density fluctuation components (i.e. SS component data SS0(n)) at each pixel clock (i.e. at each SS component address n) in accordance with the following formula. Specifically, when each pixel clock is set as a target clock (SS component address n), the weighted moving average value SS0(n) of the target clock is a weighted average of the density fluctuation component SS0(n) of the target clock n and the density fluctuation components SS(i) (i=n−k, . . . , n−1, n+1, . . . , n+k) of a predetermined number k of peripheral clocks i adjacent to the target clock n.

$$SS 1 ( n ) = ( SS 0 ( n - k ) + … + SS 0 ( n - 1 ) + ω0 \times SS 0 ( n ) + SS 0 ( n + 1 ) + … + SS 0 ( n + k ) ) / ( 2 k + ω0 )$$

Here, ω0 is a weighting coefficient of SS0(n) (here, ω0=k=8). Weighting coefficients of SS0(n−k), . . . , SS0(n−1), SS0(n+1), . . . , SS0(n+k) are 1. As mentioned, in the weighted average, the weighting coefficient @0 of the density fluctuation component SS0(n) of the target clock is set to be larger than the weighting coefficients of SS0(i) of the adjacent clocks. Further, for example, @0 is set to be identical to k.

Further, at each pixel clock n, the weighted moving average calculating circuit 41 derives an average value SSlav(n) of weighted moving average values SS1(n) of plural modulation periods.

The data processing unit 22 corrects image data on the basis of the average value SSlav(n) of the weighted moving average values SS1(n).

Here, amplitude adjustment is applied to SS1av(n) by the amplitude adjustment coefficient calculating circuit 42 and the amplitude adjusting unit 43, and SS1av(n) after the amplitude adjustment is written into the component memory 37. The amplitude adjustment is performed if required, and therefore may not be performed in some cases. Details of the amplitude adjustment is mentioned below.

The correction circuit 32 derives image data (x) after correction from image data (x) before correction on the basis of the black reference data (x) and the white reference data (x) in the reference memory 35, SS1av(x) in the component memory 37 and the like in accordance with the following formula.

$$Image data ( x ) after correction = ( Image data ( x ) before correction - Black reference data ( x ) - SS 1 av ( n ) ) \text{} / ( White reference data ( x ) - Black reference data ( x ) ) \times Maximum output data value$$

Here, the white reference data (x) is a value obtained by averaging pixel values at a primary-scanning-directional pixel position x in predetermined plural lines when reading the reference board 16 under a turning-on status of the lighting device. If the image data is expressed as 10-bit data, the maximum output data value is 1023.

Here, the aforementioned amplitude adjustment is explained.

As mentioned, weighted moving average is performed for the SS component data, and thereby, a waveform of the SS component data is smoothed. Consequently, an amplitude of the waveform of the SS component data may be smaller than an original amplitude of the SS component data. Therefore, the amplitude adjustment is performed in order to cause an amplitude of the waveform of the SS component data to agree with the original amplitude.

The amplitude adjustment coefficient calculating circuit 42(a) derives at each pixel clock n an average value of the density fluctuation component SS0(n) of a predetermined number of plural modulation periods, (b) determines an amplitude SS0amp of a waveform of average values SS0av (n) of the density fluctuation component SS0(n) in a modulation period, (c) determines an amplitude SS1amp of a waveform of average values SS1av(n) of the weighted moving average values in a modulation period, (d) derives an amplitude adjustment coefficient CA as a ratio between the amplitude SS0amp of the density fluctuation components and the amplitude SS1amp of the average values of the weighted moving average values (i.e. SS0amp/SS1amp), and (e) adjusts the weighted moving average values with the amplitude adjustment coefficient CA in accordance with the following formula.

$$SS 1 av ( n ) after adjustment = SS 1 av ( n ) before adjustment \times CA$$

For example, the aforementioned predetermined number (the number of modulation periods to derive the amplitude adjustment coefficient CA) is larger than the number of modulation periods to derive the average value of the weighted moving average values, and the amplitude adjustment coefficient CA is derived in advance. In this case, in a ready status or the like of this image processing apparatus, the number of the modulation periods is increased and the amplitude adjustment coefficient CA is derived in the modulation periods and thereby a noise component in the averages SS0av, SSlav to derive the amplitude adjustment coefficient CA is decreased, and consequently, the correct amplitude adjustment coefficient CA is obtained.

Alternatively, for example, the aforementioned predetermined number (the number of modulation periods to derive the amplitude adjustment coefficient CA) is set to be identical to the number of modulation periods to derive the average value SS1av(n) of the weighted moving averages, and the amplitude adjustment coefficient CA is derived in parallel with deriving the average value SS1av(n) of the weighted moving averages. In this case, it is not required to derive the amplitude adjustment coefficient CA in advance as mentioned.

The following part explains a behavior of the aforementioned image processing apparatus.

The image sensor 11 outputs an electric signal corresponding a scanned image (a document image, an image of the reference board 16 or the like) every line. The AFE 21 samples and holds an output signal of the image sensor 11 at a timing specified with a sampling clock generated from an SS clock by the timing signal generating circuit 24, and thereby generates and outputs output data. The channel composition circuit 31 changes an order of output data of the AFE 21 and thereby outputs image data as RGB data in an order along a scanning direction.

Firstly, the reference data and the average value of the weighted moving average of the SS component data are obtained as mentioned by image scanning of the reference board 16, and set into the reference memory 35 and the component memory 37.

Afterward, when scanning an image of a document, with a shading correction for image data of a document, the correction circuit 32 repeatedly performs correction of the SS component corresponding to each SS address n using the reference data and the average value of the weighted moving average of the SS component data as mentioned, and the image processing unit 33 performs a predetermined image process for the corrected image data and outputs the corrected image data.

As mentioned, in Embodiment 1, the data processing unit 22(a) derives a weighted moving average value of a density fluctuation component at each pixel clock from a difference between a reference board reading value in a turning-off period of the lighting device and black reference data in synchronization with modulation of the SS clock, (b) derives at each pixel clock an average value of the weighted moving average values in plural modulation periods, and (c) corrects image data on the basis of the average value of the weighted moving average values. Here, when each pixel clock is set as a target clock, the weighted moving average value of the target clock is a weighted average of the density fluctuation component of the target clock and the density fluctuation components of a predetermined number of peripheral clocks adjacent to the target clock. A weighting coefficient to the density fluctuation component of the target clock is larger than weighting coefficients to the density fluctuation components of the peripheral clocks.

Consequently, a correction value to favorably restrain a noise component due to spread spectrum is derived in a relatively short time.

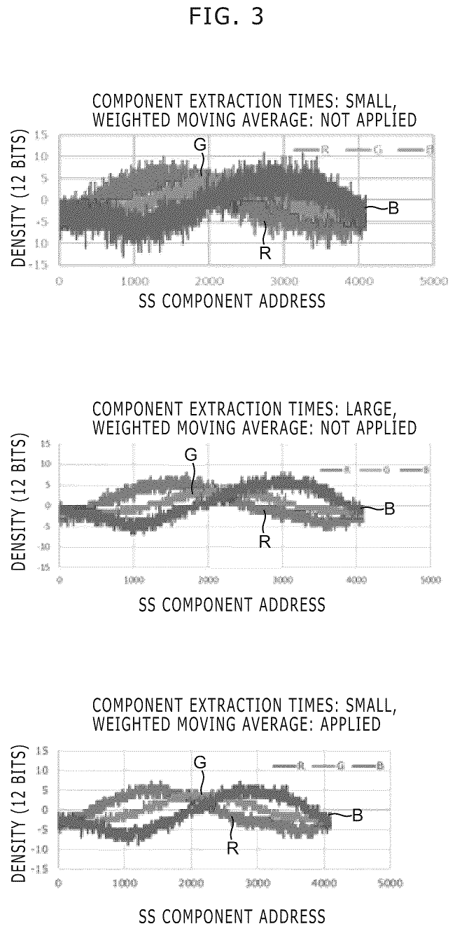

FIG. 3 shows a diagram that explains an effect of weighted moving average of SS component data. As shown in FIG. 3, for example, the weighted moving average restrains a noise component as well as when a number of modulation periods is increased to derive the SS component data. Therefore, the SS component data is derived in a small number of modulation periods and consequently, in a relatively short time, the correction value of image data is obtained.

### Embodiment 2

In Embodiment 2, the data processing unit 22 repeatedly applies correction data for one modulation period of the SS clock to image data a predetermined integer number (K) times in the aforementioned correction period and thereby corrects the image data of one correction period. Therefore, in Embodiment 2, the number of the SS component addresses n agrees with the number of pixel clocks in one modulation period.

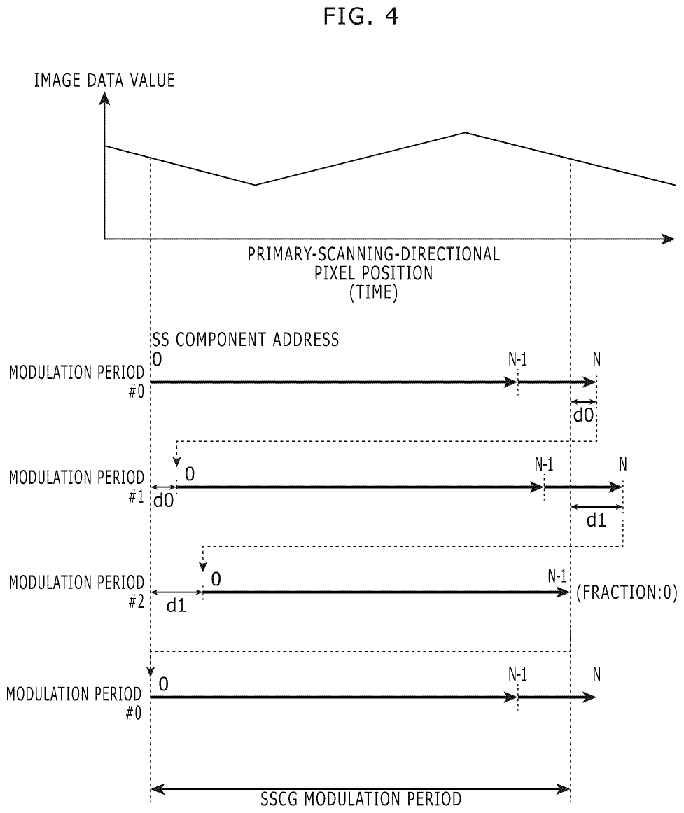

FIG. 4 shows a diagram that explains correction of image data in an image processing apparatus of Embodiment 2. In Embodiment 2, the correction data of one modulation period of the SS clock (i.e. SS component data corresponding to the SS addresses 0 to N) is generated in advance, and the SS component data corresponding to the SS addresses 0 to N for one modulation period is repeatedly applied to the image data (pixel data array along a primary scanning direction) and thereby the image data is corrected.

The modulation period is detected in the following manner. Accumulatedly adding a predetermined frequency integer division setting value is performed at each clock of the pixel clock IMGCLK, and “one modulation period” is time from when the accumulatedly added value of the predetermined frequency integer division setting value is an initial value zero until the accumulatedly added value gets equal to or larger than a frequency integer multiplication of a clock number in a modulation period (=a frequency integer multiplication setting value x SS clock number in one modulation period). Further, a difference between the accumulatedly added value and the frequency integer multiplication of the clock number at a time that the accumulatedly added value gets equal to or larger than the frequency integer multiplication of the clock number (i.e. a fraction of the accumulatedly added value) is set to an initial value of the accumulatedly added value of a next modulation period. Here, the frequency integer division setting value and the frequency integer multiplication setting value are setting values to generate the pixel clock IMGCLK from the frequency integer division and frequency integer multiplication.

In this process, as shown in FIG. 4, for example, (K=3 in FIG. 4), in a certain modulation period #i, there is a difference between a time point after one pixel clock from the last SS address n (n=N) of a modulation period and an end time point of the modulation period (i.e. fraction di), and in a next modulation period #(i+1), the fraction di appears as a primary-scanning-directional pixel position error between the component data (i.e. SS address) and image data. However, this error is always less than one pixel clock and therefore, correction precision is not declined largely.

In Embodiment 2, as mentioned, a clock number of the pixel clock is set correspondingly to a modulation period, and the data processing unit 22 acquires a value of image data every pixel clock. Further, as mentioned, if a value obtained by multiplying a clock period to the clock number does not agree with a clock number in an integer multiplication of the modulation period, then the data processing unit 22 derives a value of image data for pixel clock N outside of the modulation period (in FIG. 4, the pixel clock N in the modulation period #2) from a value of image data for the last pixel clock N−1 inside of the modulation period and a value of image data for the first pixel clock 0 of a next modulation period (here, derives as an average value of the both).

Consequently, the same number of image data for pixel clock N outside of the modulation period is obtained as the number of image data for the last pixel clock N−1 inside of the modulation period. Therefore, the number of image data for pixel clock N outside of the modulation period does not become small and the SS component data (N) to derive the average value SS1av(N) of the weighted moving average value SS1 (N) of the SS component data (N) does not become small, and consequently, a noise component in the average value SS1av(N) is restrained as well as a noise component in the average value SS1av(n) in another pixel clock.

Other parts of the configuration and behaviors of the image processing apparatus in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned Embodiment 1 or 2, the data processing unit 22(a) derives a weighted moving average value of density fluctuation components at pixel clocks for each of plural modulation period, (b) derives at each pixel clock an average value of the weighted moving average values in plural modulation periods, and (c) corrects the image data on the basis of the average value of the weighted moving average values. Alternatively, the data processing unit 22 may (a) derive an average value (simple average value) of density fluctuation components for plural modulation periods at each of pixel clocks, (b) derive a weighted moving average value of the average values at the pixel clocks in the same manner as mentioned, and (c) correct the image data on the basis of the weighted moving average value in the same manner as mentioned.

What is claimed is:

1. An image processing apparatus, comprising:
an image sensor configured to detect an image of a document or a reference board;
a lighting device configured to irradiate the document or the reference board with light;
an SSCG circuit configured to generate an SS clock obtained by modulating a reference clock with a spread spectrum of a predetermined modulation period;
an analog front end configured to sample and hold an output signal of the image sensor with a sampling clock generated from the SS clock and thereby generate sampling data;
a channel composition circuit configured to convert the sampling data to image data; and
a data processing unit configured to process the image data with a pixel clock generated on the basis of the SS clock;
wherein the data processing unit (a) derives a weighted moving average value of a density fluctuation component at each pixel clock from a difference between a reference board reading value in a turning-off period of the lighting device and black reference data in synchronization with modulation of the SS clock, (b) derives at each pixel clock an average value of the weighted moving average values in plural modulation periods, and (c) corrects the image data on the basis of the average value of the weighted moving average values;
when each pixel clock is set as a target clock, the weighted moving average value of the target clock is a weighted average of the density fluctuation component of the target clock and the density fluctuation components of a predetermined number of peripheral clocks adjacent to the target clock; and
a weighting coefficient to the density fluctuation component of the target clock is larger than weighting coefficients to the density fluctuation components of the peripheral clocks.

2. The image processing apparatus according to claim 1, wherein the data processing unit (a) derives at each pixel clock an average value of a predetermined number of density fluctuation components, (b) determines an amplitude of a waveform of average values of the density fluctuation components in the modulation period, (c) determines an amplitude of a waveform of average values of the weighted moving average values in the modulation period, (d) set an amplitude adjustment coefficient as a ratio between the amplitude of the density fluctuation components and the amplitude of the weighted moving average values, and (e) adjust the weighted moving average value using the amplitude adjustment coefficient.

3. The image processing apparatus according to claim 2, wherein the predetermined number is larger than a number of the modulation periods to derive the average value of the weighted moving average values; and
the amplitude adjustment coefficient is derived in advance.

4. The image processing apparatus according to claim 2, wherein the predetermined number is identical to a number of the modulation periods to derive the average value of the weighted moving average values; and
the amplitude adjustment coefficient is derived in parallel with deriving the average value of the weighted moving average values.

5. The image processing apparatus according to claim 1, wherein a clock number of the pixel clock is set correspondingly to the modulation period; and
the data processing unit (a) acquires a value of the image data at each pixel clock, (b) if a value of a product of the clock number and a clock period of the pixel clock does not agree with a clock number of a frequency integer multiplication of the modulation period, derives a value of the image data at a pixel clock outside of the modulation period from a value of the image data of a last pixel clock in the modulation period and a value of the image data of a head pixel clock in a next modulation period.
